(19) United States
(12) Patent Application Publication
(10) Pub. No.: US 2009/0294525 A1
(43) Pub. Date: Dec. 3, 2009

(54) IDENTIFICATION CARD COMPRISING AN IMAGE AND PRODUCTION METHOD THEREFOR

(75) Inventors: Michael Wanjek, Nittenau (DE); Anton Brunner, Koetzting (DE)

Correspondence Address: BLACK LOWE & GRAHAM, PLLC, 701 FIFTH AVENUE, SUITE 4800, SEATTLE, WA, 98104, US

(73) Assignee: MUEHLBAUER AG, Roding (DE)

(21) Appl. No.: 12/091,731

(22) PCT Filed: Oct. 24, 2006
(86) PCT No.: PCT/EP2006/067702

§ 371 Date: Jul. 21, 2009

(30) Foreign Application Priority Data
Oct. 27, 2005 (DE) 10 2005 051 416.2

(51) Int. Cl. G06K 5/00; B41F 33/00

(52) U.S. Cl. 235/380; 101/483

(57) ABSTRACT

The invention relates to a method for producing and processing an image on a card substrate of an identification card, comprising the following steps:
printing a colour image onto a surface of the card substrate by means of a printer;
optically scanning the surface of the printed image and detecting individual image components of the printed image, which differ from one another in terms of their colour features, by means of an optical detection and evaluation unit;
calculating coordinates of boundary lines between the detected image components, which boundary lines represent the contours of the image components, by means of a calculation unit, and
heating the card substrate material in lines below the surface of a surface layer of the card substrate along the boundary lines, by moving a laser along the surface plane of the card substrate using the calculated coordinates. An identification card comprising a colour image is shown.

The invention relates to a method for producing and processing an image on a card substrate of an identification card, and to the identification card, according to the preambles of Claims 1, 7 and 8.

Identification cards in the form of plastic cards in the credit card format or in the ID card format, which can also be included within a passport, must be produced and brought into circulation with a high level of security against forgery. To this end, such identification documents often have a colour image on their surface, in order to make it easier and faster for a person or machine carrying out checks to identify the person to whom this ID belongs and to prevent transfer of the identification card.

For protection against unauthorised alteration of such printed images, use has to date been made of protective films which optionally cover the entire card body including the image components of the colour image. However, such protective films increase the production costs due to the value of their material and the additional necessary production step for applying them to the surface of the card body. Moreover, it is conceivable for the protective film subsequently to be removed from the card body in order to alter, remove or replace the colour image.

Added to this is the fact that such protective films are often subject to wear, which therefore does not provide effective durable protection against intentional or unintentional alteration of the colour image.

EP 0 537 484 A1 discloses a recording medium with colour image information, which is in the form of a security or ID card. The image information is broken down into a light/dark portion and a coloured portion. The light/dark portion is congruently superposed with the colour image information. One of these portions is irreversibly introduced into the recording medium by means of a laser. Here, the black/white portions are preferably burned in by means of the laser and superposed with the coloured portions. As a result, the quality of the applied images, which may be photographs of individuals, depends on their content of black areas, and moreover such black areas must necessarily be present in order to permit such a combined production method.

This method often comes unstuck when it is desired to create an image of a blonde person with fair skin, since the small or non-existent black portion leads to a much poorer image quality in terms of resolution and contrast.

Accordingly, the object of the present invention is to provide a method for producing and processing an image on a card substrate of an identification card, and also an identification card, by means of which it is possible to provide a forgery-proof representation, preferably a colour representation of a person, on the card with a high image quality, irrespective of the black portions in the image to be depicted.

This object is achieved in terms of the method by the features of Claims 1 and 7 and in terms of the product by the features of Claim 8.

One essential aspect of the invention lies in the fact that, in a method for producing and processing an image on a card substrate of an identification card, the following steps are carried out:
printing a colour image onto a surface of the card substrate by means of a printer;
optically scanning the surface of the printed image and detecting individual image components of the printed image, which differ from one another in terms of their colour features, by means of an optical detection and evaluation unit;
calculating coordinates of boundary lines between the detected image components, which boundary lines represent the contours of the image components, by means of a calculation unit, and
heating the card substrate material in lines below the surface of a surface layer of the card substrate along the boundary lines, by moving a laser along the surface plane of the card substrate using the calculated coordinates.

Such a method advantageously has the possibility, regardless of the proportion of black components within the colour image, of producing a forgery-proof identification card with the associated colour image even if a protective film on the surface of the card body is not used.

By tracing the contours of a selected image component which has been delimited from another image component of the colour image and selected beforehand by means of suitable detection and evaluation steps using software, it is possible for example to permanently highlight the outer shape of a person's head as a burnt-in line, regardless of whether the background is black or white or grey. This leads to a forgery-proof identification card since, although the printed components of the printed colour image can be removed from outside due to the fact that the image is arranged on the surface of the card substrate, the contours or boundary lines burnt in below the surface of a surface layer applied to the card substrate nevertheless cannot be removed without destroying the card body as a whole. Here, the card can be printed with the colour photograph from outside by means of dysublimation using an inkjet printer.

The contours between the individual image components, which can be converted into black lines using the laser by moving the laser along the surface plane of the card body, may include not just the outer contours of a person's head in a passport photograph but rather all the facial contours of the person's head. As a result, a clear representation of the person's head in black lines is possible, which is unsusceptible to manipulation without destroying the identification card as a whole.

The surface layer material is selected such that it is transparent to the laser light of the employed laser with its associated wavelength, so that a burning process takes place below the surface layer.

The transparent surface layer, which may be designed for example as a separate film or else is integrated within the card substrate, is passed through by the laser beam using a laser writer and produces the blackened line area below this layer. There, the laser beam energy is absorbed by the underlying material, as a result of which the material thermally decomposes and changes colour, and thus the black lines are produced.

The step of heating by means of the laser beam with a temperature at the heating site should be carried out in such a way that, either by moving the laser beam in a suitably slow manner or by introducing a suitable amount of energy, the necessary burning temperature in relation to a burning process of the card substrate material that is to be thermally heated is reached, so as to form black lines. To this end, use is preferably made of a solid-state laser with a wavelength of 1064 nm, since such lasers permit a high dissipation of energy. In this way, card substrates made of a material such as hard PVC can easily be provided with black lines of precise linear orientation.

Such black lines are unsusceptible to etching processes and the like which act on the surface of the card substrate from outside.

The different colour features are preferably determined by comparing the pixels. Alternatively, adjacent colour brightness values and colour contrast values can be used to define boundary lines between adjacent image components having different colour features.

For the scanning and detection of such different colour features, use is made of the detection and evaluation unit, which comprises for example a camera with associated evaluation software. Such a detection and evaluation unit moves over the card substrate to scan it or takes an overall recording of the image or photograph in order to detect the data as a function of the spatial coordinates in relation to the card body and then to calculate the spatial coordinates of the resulting boundary lines between the individual image components.

These spatial coordinates of the boundary lines are used to move the displaceable laser unit parallel to the surface plane of the card body along the contour of the boundary lines and thus to obtain a black line caused by the impingement of a laser beam directed as perpendicular as possible to the surface plane, so as to avoid reflections on the surface.

As an alternative to the sequence of steps of the production method in which firstly the image is printed onto the card substrate and then the boundary lines between the image components are traced by the laser, it is possible in a first step to calculate the contours between the image components of the photograph which has not yet been printed onto the card body, then to move the laser so as to form the black lines on the card body along the boundary lines determined by means of the spatial coordinates, and finally to print the colour image onto the surface of the card body in a printing process. As a result, the printing operation is moved to the end of the production process, so as to obtain for example an operation of drying the printed surface for a sufficient time with the identification card in the laid-down state.

All the features disclosed in the application documents are claimed as essential to the invention in so far as they are novel either individually or in combination with one another over the prior art.

1. A method for producing and processing an image on a card substrate of an identification card, the method comprising:
printing a color image onto a surface of the card substrate by means of a printer;
optically scanning the surface of the printed image and detecting individual image components of the printed image, which differ from one another in terms of their color features, by means of an optical detection and evaluation unit;
calculating coordinates of boundary lines between the detected image components, which boundary lines represent the contours of the image components, by means of a calculation unit, and
heating the card substrate material in lines below the surface of a surface layer of the card substrate along the boundary lines, by moving a laser along the surface plane of the card substrate using the calculated coordinates, wherein the different color features that are measured are at least one of different color brightness values, colour contrast values or different color pixel values.

2. The Method according to claim 1, wherein heating is performed at a temperature which is above the burning temperature of the card substrate material, so as to form black lines.

3. The method according to claim 1, wherein the calculated coordinates which represent the boundary lines between the image component of a background of the image and the image component of a representation of a person are selected.

4. The method according to claim 1, wherein the laser used is a solid-state laser with a wavelength of 1064 nm.

5. The method according to claim 4, wherein the surface layer material used is a material which is transparent to laser light of the laser used.

6. A method for producing and processing an image on a card substrate of an identification card, the method comprising:
detecting individual image components of an image that is to be printed on, which differ from one another in terms of their color features by means of a detection and evaluation unit, and
calculating coordinates of boundary lines between the image components,
heating the card substrate material in lines below the surface of a surface layer of the card substrate along the boundary lines to be printed on, by moving a laser along the surface plane of the card substrate, and
printing the color image onto the surface of the card substrate by means of a printer, wherein the different color features that are measured are at least one of different color brightness values, color contrast values or different color pixel values.

7. An identification card comprising
a card substrate and a color image arranged thereon, wherein boundary lines between different image components of the color image are formed as black lines below a surface of a surface layer of the card substrate.
